(19) United States
(12) Patent Application Publication
(10) Pub. No.: US 2017/0353642 A1
(43) Pub. Date: Dec. 7, 2017

(54) DRIVER STATE MONITORING SYSTEM

(71) Applicant: HYUNDAI MOTOR COMPANY, Seoul (KR)

(72) Inventor: Il Yong YOON, Seoul (KR)

(21) Appl. No.: 15/355,300

(22) Filed: Nov. 18, 2016

(30) Foreign Application Priority Data
Jun. 1, 2016 (KR) 10-2016-0068185

(51) Int. Cl. H04N 5/225; B60W 40/08; G06K 9/00; G08B 21/06

(52) U.S. Cl. CPC H04N 5/2256; G08B 21/06; B60W 40/08; G06K 9/00302; G06K 9/00335

(57) ABSTRACT

A driver state monitoring system includes a first lighting module for driving a first lighting device, a camera for acquiring an image, a second lighting module for driving a second lighting device by synchronizing the second lighting device with the first lighting device wirelessly, and a controller for analyzing the image acquired by the camera to recognize a driver state.

### CROSS-REFERENCE TO RELATED APPLICATION

This application claims the benefit of priority to Korean Patent Application No. 10-2016-0068185, filed on Jun. 1, 2016, with the Korean Intellectual Property Office, the disclosure of which is incorporated herein in its entirety by reference.

### TECHNICAL FIELD

The present disclosure relates to a driver state monitoring system that improves facial recognition performance by providing an indirect lighting device in an interior lamp (a map lamp), a cluster, or the like, within a vehicle and driving the indirect lighting device together with a main lighting device only when there is no external light.

### BACKGROUND

In general, when a driver is not paying attention to the road ahead or is driving while drowsy, a driver state monitoring system detects such a dangerous situation in advance and gives the driver a warning. The driver state monitoring system may provide functions of face recognition of a driver using a camera provided in the interior of a vehicle, remote monitoring of objects in the interior of the vehicle, or the like.

The driver state monitoring system mostly operates in an infrared band in order to minimize the influence of external light. A facial recognition function of the driver state monitoring system may be implemented based on learning task using a face imaging database (DB). An existing face imaging database is based on a general light source rather than an infrared light source, and, in many cases, a shadow on the face due to the effects of an indirect light source is less obtrusive or visible.

However, one or two infrared light emitting diodes (LEDs) are used in the driver state monitoring system, and the infrared LED is not a surface light source, but is a point light source. Thus, the one or two infrared LEDs tend to cast a very obtrusive shadow on the face. In particular, when there is no external light in the evening, the shadow on the face may be more visible.

As stated above, since the conventional driver state monitoring system uses a point light source such as an infrared LED for face recognition, when the angle of the face is changed, the shadows of nose, cheekbones, an eyeglass frame, or the like may degrade facial recognition performance.

In addition, the driver state monitoring system uses an infrared bandpass filter in order to minimize the influence of external light and the efficiency of an image sensor is not satisfactory in an infrared band. Thus, a relatively high current is required for the infrared LED for lighting. When the indirect light source is frequently driven, there are difficulties in use due to issues of heat, power consumption, lifespan, and the like.

### SUMMARY

The present disclosure has been made to solve the above-mentioned problems occurring in the prior art while advantages achieved by the prior art are maintained intact.

An aspect of the present disclosure provides a driver state monitoring system that improves face recognition performance by providing an indirect lighting device in an interior lamp (a map lamp), a cluster, or the like, within a vehicle and driving the indirect lighting device together with a main lighting device only when there is no external light.

According to an aspect of the present disclosure, a driver state monitoring system may include: a first lighting module driving a first lighting device; a camera acquiring an image; a second lighting module driving a second lighting device by synchronizing the second lighting device with the first lighting device wirelessly; and a controller analyzing the image acquired by the camera to recognize a driver state.

The second lighting module may include: a light receiving element detecting an ambient light signal; a low pass filter selectively passing a low frequency component of the light signal detected by the light receiving element; a logic element outputting a second control signal depending on output signals of the light receiving element and the low pass filter; a driver IC driving the second lighting device depending on the second control signal; and a light emitting element outputting infrared light to the second lighting device under control of the driver IC.

The light receiving element may be provided as at least one photodiode.

A cutoff frequency of the low pass filter may be less than a frame rate of the camera.

When there is no low frequency component passing through the low pass filter, the logic element may synchronize the second control signal with a high frequency component of the light signal to control the second lighting device to be turned on.

The logic element may include a NOT gate and an AND gate.

The second lighting module may be provided in a map lamp or a cluster within a vehicle.

According to another aspect, the present disclosure provides a driver state monitoring system, which may include a driver state recognition device for recognizing a driver state by analyzing an image acquired via a camera, and further include a main light, and an indirect lighting device driven according to the indirect lighting device synchronizing with the main light of the driver state recognition device.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a block diagram of a driver state monitoring system, according to exemplary embodiments of the present disclosure;

FIG. 2 illustrates a circuit diagram of a second lighting module illustrated in FIG. 1; and

FIG. 3 illustrates graphs of output signals from a light receiving element illustrated in FIG. 2.

### DETAILED DESCRIPTION

Hereinafter, exemplary embodiments of the present disclosure will be described in detail with reference to the accompanying drawings.

The present disclosure provides a technology for improving facial recognition performance of a driver state monitoring (DSM) apparatus. Since the present disclosure improves the quality of a facial image using infrared indirect lighting, the influences of the direction, angle, or expression of a face, eyeglasses, and the like may be minimized.

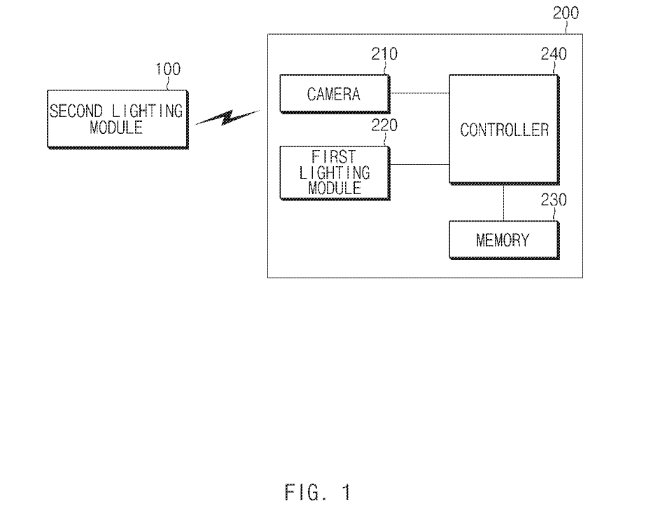

FIG. 1 illustrates a block diagram of a driver state monitoring system, according to exemplary embodiments of the present disclosure.

The driver state monitoring system, in some implementations, includes a second lighting module 100 and a recognition module 200.

The second lighting module 100 may be provided in a position where lighting is used, such as a map lamp (an interior lamp), a cluster, or the like, within a vehicle. In some exemplary embodiments, the second lighting module 100 is provided in the position of the map lamp or the cluster within the vehicle as an example, but is not limited thereto. Alternatively, the second lighting module 100 may be provided in a predetermined position within the vehicle.

The second lighting module 100 may sense an ambient light signal (hereinafter also referred to as “ambient light”) and determine whether or not there is an infrared component. When there is no infrared component in the sensed ambient light, the second lighting module 100 may allow a second lighting device (an indirect lighting device) to synchronize with a first lighting device (a main lighting device) of the recognition module 200 wirelessly, and drive the second lighting device. The ambient light includes an external light signal and a light signal of the first lighting device.

The recognition module 200 may capture an image of the interior of the vehicle and perform functions of facial recognition, eye tracking, or the like, on the basis of the captured image. The recognition module 200 may detect a driver state through facial recognition, eye tracking, or the like. The recognition module 200 may be provided as a facial recognition system, an eye tracker, or the like.

The recognition module 200, in some implementations, includes a camera 210, a first lighting module 220, a memory 230 and a controller 240.

The camera 210 may acquire the image of the interior of the vehicle under control of the controller 240. For example, the camera 210 may acquire a facial image of a driver. The camera 210 may acquire images at designated intervals.

The camera 210 may be provided as at least one of an image sensor such as an infrared image sensor, a charge coupled device (CCD) image sensor, a complementary metal oxide semi-conductor (CMOS) image sensor, a charge priming device (CPD) image sensor and a charge injection device (CID) image sensor.

The first lighting module 220 may be the main lighting of the driver state monitoring system, and may operate by being synchronized with the exposure of the camera 210. The first lighting module 220 may generate infrared light under control of the controller 240. The first lighting module 220 includes at least one light source generating infrared light, such as a flash lamp, a halogen lamp or a light emitting diode (LED).

In other words, the first lighting module 220 may supply power to the light source and radiate the infrared light for an exposure time of the camera 210 during image capturing.

The memory 230 may store a program, input/output data, and the like, for controlling the operation of the driver state monitoring system. The memory 230 may store reference facial images, facial features, a facial recognition program, an eye tracking program, and the like.

The memory 230 may be provided as at least one of storage media such as a flash memory, a hard disk, a secure digital (SD) card, a random access memory (RAM), a read only memory (ROM) and a web storage.

The controller 240 may analyze the image acquired by the camera 210 to recognize a face or perform eye-tracking through eye gaze detection. When the controller 240 controls the camera 210 to acquire the image, it may control the first lighting module 220 to radiate the infrared light.

The controller 240 may perform facial recognition and eye-tracking using known facial recognition and eye-tracking techniques or the like. In other words, the controller 240 may recognize the driver's face or gaze direction using the facial recognition program or the eye-tracking program stored in the memory 230.

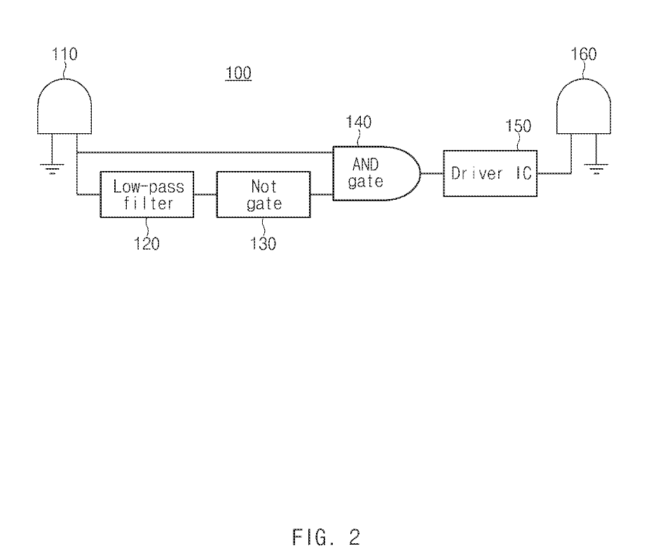

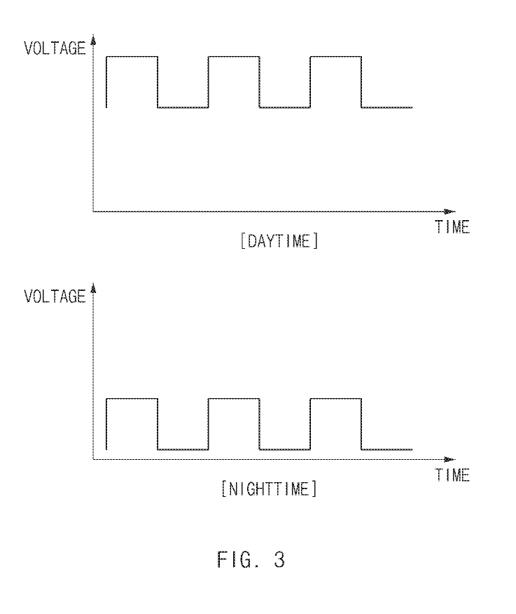

FIG. 2 illustrates a circuit diagram of a second lighting module 100 illustrated in FIG. 1, and FIG. 3 illustrates graphs of output signals from a light receiving element illustrated in FIG. 2.

As illustrated in FIG. 2, the second lighting module 100, in some implementations, includes a light receiving element 110, a low pass filter 120, a first logic element 130, a second logic element 140, a driver integrated circuit (IC) 150 and a light emitting element 160.

The light receiving element 110 may sense an ambient light signal (ambient light) and convert light energy into electrical energy. The ambient light includes a signal from external light such as sunlight and a light signal of the first lighting device (the main lighting device) of the recognition module 200.

The light receiving element 110 may detect the ambient light signal and convert the detected light signal into an electrical signal to output the converted signal. The light receiving element 110 may be provided as at least one photodiode, at least one optical sensor, or the like.

The low pass filter 120 may pass a low frequency signal with a frequency lower than or equal to a cutoff frequency among frequencies contained in the output signal of the light receiving element 110. In other words, the low pass filter 120 may only pass a low frequency component of the output signal of the light receiving element 110.

Since the cutoff frequency of the low pass filter 120 is less than a frame rate of the camera 210, the low pass filter 120 may remove a flash component of the first lighting device and selectively pass only the external light signal. In other words, the low pass filter 120 may remove the light signal of the first lighting device from the ambient light detected by the light receiving element 110 and selectively pass only the external light signal.

The first logic element 130 may receive the output of the low pass filter 120 and invert the same. The first logic element 130 may be configured as a NOT gate. For example, when there is a low frequency component filtered through the low pass filter 120, the first logic element 130 outputs “0”, and when there is no low frequency component, the first logic element 130 outputs “1”.

The second logic element 140 may receive the output of the first logic element 130 and the output of the light receiving element 110, and calculate an AND operation of the outputs of the first logic element 130 and the light receiving element 110. The second logic element 140 may output a second control signal to be applied to the second lighting device (the indirect lighting device) depending on the AND operation. The second logic element 140 may be configured as an AND gate, and the second control signal may be “1” for turning a light on or “0” for turning a light off.

For example, when there is no low frequency component filtered through the low pass filter 120 and infrared components of external light are insufficient, the second logic element 140 outputs “1”, and when there is no low frequency component filtered through the low pass filter 120 and infrared components of external light are sufficient, the second logic element 140 outputs “0”.

When the output signal (the presence or absence of the low frequency component) of the first logic element 130 is “1”, the second logic element 140 may determine an output signal depending on the output signal (high frequency component) of the light receiving element 110. In other words, if the output signal of the first logic element 130 is “1”, when the output signal of the light receiving element 110 is “1”, the second logic element 140 outputs “1”, and when the output signal of the light receiving element 110 is “0”, the second logic element 140 outputs “0”.

Meanwhile, when the output signal of the first logic element 130 is “0”, the second logic element 140 outputs “0”, regardless of the output signal of the light receiving element 110. In other words, when the low frequency component is filtered through the low pass filter 120, the second logic element 140 outputs “0”, regardless of the ambient light signal detected by the light receiving element 110.

The first logic element 130 and the second logic element 140 may output the second control signal “1” only when there is no low frequency component passing through the low pass filter 120. In other words, the first logic element 130 and the second logic element 140 may output a signal commanding the operation of the second lighting device only when there is no low frequency component passing through the low pass filter 120.

The driver IC (driver) 150 may drive the light emitting element 160 depending on the second control signal output from the second logic element 140. Here, the driver IC 150 may synchronize the second control signal with a first control signal to be applied to the first lighting device to drive the light emitting element 160.

In order to synchronize the second control signal with the first control signal output from the controller 240, the driver IC 150 may synchronize the second control signal with the high frequency component of the signal output from the light receiving element 110 to drive the light emitting element 160. In other words, when the first lighting device of the recognition module 200 is driven, the driver IC 150 may drive the second lighting device also.

The light emitting element 160 may generate infrared light under control of the driver IC 150. The light emitting element 160 may be provided as at least one infrared LED. In other words, the light emitting element 160 may be turned on or off under control of the driver IC 150.

As illustrated in FIG. 3, for example, during nighttime, when infrared components of external light are not sufficient and there is no low frequency component passing through the low pass filter 120, one input of the second logic element 140 is always “1”, and thus, the second control signal may be synchronized with a frequency of the signal output from the light receiving element 110 (a frequency of the first lighting device) to drive the second lighting device.

Meanwhile, for example, during daytime, when infrared components of external light are sufficient and there is a low frequency component passing through the low pass filter 120, one input of the second logic element 140 is always “0”, and thus, the second lighting device may not be driven regardless of the output signal of the light receiving element 110.

As stated above, according to exemplary embodiments of the present disclosure, when there is no infrared component of external light, the second lighting device may be driven by being synchronized with the first lighting device of the driver state monitoring system wirelessly. Therefore, the driver state monitoring system may provide enhanced facial recognition performance, and the reliability of the driver state monitoring system may be improved.

Hereinafter, the operation of the second lighting module 100 will be detailed.

The light receiving element 110 of the second lighting module 100, in some implementations, senses an ambient light signal and outputs an electrical signal corresponding thereto.

The low pass filter 120 may filter a low frequency signal with a frequency lower than or equal to a cutoff frequency among frequencies of the electrical signal output from the light receiving element 110. In other words, the low pass filter 120 may only extract an infrared component of external light detected by the light receiving element 110.

When the low frequency component is filtered through the low pass filter 120, the first logic element 130 may output “0”, and when the low frequency component is not filtered through the low pass filter 120, the first logic element 130 may output “1”.

The second logic element 140 may receive the output signal of the first logic element 130 and the output signal of the light receiving element 110 and calculate an AND operation. The output signal of the light receiving element 110 may be a high frequency component of the external light.

The second logic element 140 may output a second control signal depending on results of the AND operation. In other words, the second logic element 140 may output the control signal commanding the driving or non-driving of the second lighting device depending on the results of the AND operation of the signal from the first logic element 130 and the signal from the light receiving element 110.

The driver IC 150 may drive the light emitting element 160 to output infrared light depending on the control signal output from the second logic element 140. The light emitting element 160 may receive power and convert electrical energy into light energy under control of the driver IC 150.

As set forth above, according to exemplary embodiments of the present disclosure, the driver state monitoring system may improve the facial recognition performance by providing the indirect lighting device in an interior lamp (a map lamp), a cluster, or the like, within the vehicle and driving the indirect lighting device together with the main lighting device only when there is no external light.

In addition, the driver state monitoring system may improve the quality of an image captured by the camera with the use of the indirect lighting device, thereby enabling enhanced facial recognition. Thus, the drowsiness detection performance of the driver state monitoring system may also be improved based on the enhanced facial recognition.

Furthermore, the indirect lighting device may be driven only when there is no low frequency component in external light. Thus, heat, power consumption, and lifespan issues of the indirect lighting device may be solved. Therefore, the reliability of the driver state monitoring system may be increased.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A driver state monitoring system comprising:
a first lighting module for driving a first lighting device;
a camera for acquiring an image;
a second lighting module for driving a second lighting device by synchronizing the second lighting device with the first lighting device wirelessly; and
a controller for analyzing the image acquired by the camera to recognize a driver state.

2. The driver state monitoring system according to claim 1, wherein the second lighting module comprises:
a light receiving element for detecting an ambient light signal;
a low pass filter for selectively passing a low frequency component of the light signal detected by the light receiving element;
a logic element for outputting a second control signal depending on output signals of the light receiving element and the low pass filter;
a driver IC for driving the second lighting device depending on the second control signal; and
a light emitting element for outputting infrared light to the second lighting device under control of the driver IC.

3. The driver state monitoring system according to claim 2, wherein the light receiving element is provided as at least one photodiode.

4. The driver state monitoring system according to claim 2, wherein a cutoff frequency of the low pass filter is less than a frame rate of the camera.

5. The driver state monitoring system according to claim 2, wherein when there is no low frequency component passing through the low pass filter, the logic element synchronizes the second control signal with a high frequency component of the light signal to control the second lighting device to be turned on.

6. The driver state monitoring system according to claim 5, wherein the logic element includes a NOT gate and an AND gate.

7. The driver state monitoring system according to claim 1, wherein the second lighting module is provided in a map lamp or a cluster within a vehicle.

8. A driver state monitoring system comprising:
a driver state recognition device for recognizing a driver state by analyzing an image acquired via a camera, and further including a main light; and
an indirect lighting device driven according to the indirect lighting device synchronizing with the main light of the driver state recognition device.

9. The driver state monitoring system according to claim 8, wherein the indirect lighting device comprises:
a light receiving element for detecting an ambient light signal;
a low pass filter for selectively passing a low frequency component of the light signal detected by the light receiving element;
a logic element for outputting a control signal depending on output signals of the light receiving element and the low pass filter;
a light emitting element for outputting infrared light; and
a driver IC for driving the light emitting element depending on the control signal.

10. The driver state monitoring system according to claim 9, wherein the light receiving element is provided as at least one photodiode.

11. The driver state monitoring system according to claim 9, wherein a cutoff frequency of the low pass filter is less than a frame rate of the camera.

12. The driver state monitoring system according to claim 9, wherein when there is no low frequency component passing through the low pass filter, the logic element synchronizes the second control signal with a high frequency component of the light signal to control the light emitting element to be turned on.

13. The driver state monitoring system according to claim 12, wherein the logic element includes a NOT gate and an AND gate.

14. The driver state monitoring system according to claim 8, wherein the indirect lighting device is provided in a map lamp or a cluster within a vehicle.
